(19) United States
(12) Patent Application Publication
(10) Pub. No.: US 2025/0088536 A1
(43) Pub. Date: Mar. 13, 2025

(54) Deceptive Resistance to Adversary Cyber Operations (DRACO)

(71) Applicant: The United States of America, As Represented by the Secretary of the Navy, Arlington, VA (US)

(72) Inventors: Mathieu Couillard, Monterey, CA (US); John Arquilla, Monterey, CA (US); Britta Hale, Monterey, CA (US)

(21) Appl. No.: 18/883,808

(22) Filed: Sep. 12, 2024

Related U.S. Application Data
(60) Provisional application No. 63/538,027, filed on Sep. 12, 2023.

(51) Int. Cl. H04L 9/40

(52) U.S. Cl. CPC H04L 63/1491; H04L 63/0209; H04L 63/1425

(57) ABSTRACT

A system and method for deceptive resistance to adversary cyber operations is disclosed. The system includes a deception server that impersonates an operational server using network traffic redirection and network address translation (NAT). The server logs network events, which are analyzed by an analytics server generating real-time dashboards. A network firewall manages connections to the deception network, and a router handles traffic and terminates VPN connections. The deception server emulates multiple protocols, including HTTP, SSH, and FTP, to engage cyber threat actors. The analytics server employs machine learning to detect and categorize attack patterns. The system features cloud-based scalability, dynamic traffic management, and multiple honeypots simulating different services and operating systems. It can generate alerts for abnormal attack patterns and offers customizable configurations to tailor responses to various cyber threats.

### CROSS-REFERENCE TO RELATED APPLICATIONS

This application claims priority to U.S. Provisional Patent Application No. 63/538,027, filed on Sep. 12, 2023, which is incorporated by reference in its entirety.

### BACKGROUND

The present disclosure relates to the enhancement of cybersecurity through the deployment of advanced deception techniques, specifically focusing on improved defense against adversary cyber operations. This disclosure pertains to innovative methods of cybersecurity deception, particularly the use of deception as a service (DaaS) through cloud-hosted honeypots and network redirection technologies, which provide an effective yet secure approach to misleading and identifying malicious actors in both operational and research environments. These methods offer significant advantages in scenarios where traditional cybersecurity defenses are insufficient, such as protecting critical infrastructure, government networks, and cloud-based services from advanced persistent threats (APTs) or state-sponsored cyber espionage activities.

In today's cyber threat landscape, organizations face increasingly sophisticated attacks that can easily bypass traditional perimeter defenses. Cyber incidents are unpredictable and can result in significant damage to organizational assets, including sensitive data, intellectual property, and operational systems. Common cyber defense techniques, such as firewalls and intrusion detection systems, often fail to provide effective monitoring and engagement with attackers once they have infiltrated a network. The risk is compounded by the challenges in attributing and responding to these threats, particularly when cybercriminals use anonymization techniques and botnets to evade detection. Current cybersecurity protocols focus heavily on preventing attacks, but they often neglect the importance of ongoing engagement and intelligence gathering once an attack is underway, limiting the ability of defenders to respond effectively.

Cybersecurity professionals often lack the tools to continuously monitor attacker behavior in a way that provides deep insights into adversary tactics, techniques, and procedures (TTPs). The overwhelming volume of traffic and data from multiple systems can saturate security operations teams, making it difficult to distinguish real threats from false positives. Traditional security alerts focus on isolated events but fail to account for broader attack patterns, often leading to alarm fatigue and missed opportunities to detect and stop advanced cyber threats. These challenges are exacerbated by the evolving nature of cyberattacks, including multi-stage attacks that blend reconnaissance, exploitation, and persistence over extended time frames, making real-time monitoring and response critical to maintaining network integrity.

The Deceptive Resistance to Adversary Cyber Operations (DRACO) system provides a solution to these challenges by enabling continuous engagement with cyber adversaries through its deception-as-a-service architecture. By leveraging cloud-hosted honeypots and network address translation (NAT) technologies, DRACO ensures that attackers are engaged and monitored from the initial compromise to the final stages of the attack, without exposing the operational network to significant risk. This system allows security professionals to gather valuable intelligence on adversarial behavior, including the identification of attack infrastructure and techniques, while keeping production systems secure. DRACO also enables rapid response interventions by automatically redirecting malicious traffic to deception networks, allowing defenders to isolate and neutralize threats before they can cause widespread damage.

The present disclosure proposes a comprehensive solution for overcoming these problems and improving cybersecurity defense.

### BRIEF SUMMARY

A system for deceptive resistance to adversary cyber operations is disclosed. The system comprises a deception server within a deception network, which responds to cyber threat actors by impersonating an operational server on the operational network. This is achieved using network traffic redirection and network address translation (NAT), allowing the system to log relevant network events generated by the cyber threat actor. An analytics server, also part of the deception network, receives and stores these logs, generating visual analytics in the form of dashboards for end users. The system includes a network firewall that manages connections between the deception network and the Internet, and facilitates the administration of the deception network. A router routes traffic between components of the deception network and terminates virtual private network (VPN) connections to the operational network.

The analytics server may be integrated into the deception network itself, providing localized processing capabilities. Additionally, the system may include a border router located outside the operational network, designed to route attack traffic to a NAT service, ensuring the isolation of malicious traffic from the operational network. The NAT service changes the destination address of attack traffic to reflect the deception server's address while changing the source address of responses to simulate that of the operational server. The deception server is capable of emulating various protocols such as Hypertext Transfer Protocol (HTTP), Secure Shell (SSH), and File Transfer Protocol (FTP), ensuring adaptability to different types of cyberattacks.

Further enhancing its capabilities, the analytics server includes machine learning algorithms that automatically detect and categorize attack patterns based on adversary behavior. The network firewall is configured to block unauthorized outbound traffic from the deception network, adding an additional layer of protection. A visualization dashboard on the analytics server provides real-time monitoring of adversary interactions, allowing system administrators to stay informed of ongoing attacks. A configuration management interface enables administrators to customize the system's responses to various types of cyber threats, tailoring the deception strategies to emerging attack tactics. The system can also generate alerts when abnormal attack patterns are detected, ensuring that defenders are promptly informed of unusual activity.

Moreover, the router logs all network traffic between the operational and deception networks, creating an audit trail of interactions. The deception server may be hosted on a cloud platform, leveraging dynamic scaling to accommodate varying levels of attack traffic. The deception network itself includes multiple honeypots that simulate different services or operating systems, enhancing the system's ability to engage a wide range of cyber threats.

In another embodiment, a method is disclosed for deploying a cloud-hosted deceptive defense system. The method involves simulating network resources on a cloud-hosted deception server and redirecting unauthorized traffic to this server through a NAT service. The system captures and logs interactions with adversaries, analyzing patterns of attack to provide insights. The method also ensures that the deception network is isolated from the secure infrastructure to prevent unauthorized access.

Network events recorded by the system may include detailed information about the adversary's network infrastructure and location. Reports generated from these events may include specific recommendations for improving network defenses, based on observed adversary tactics. Additionally, the NAT service adjusts the rerouting of traffic based on the detected type of cyberattack, ensuring the system adapts dynamically to the threat environment.

A system for isolating and analyzing cyber adversary activity is also disclosed. This system features a deception network that reroutes attack traffic away from the operational network. A deception server simulates real network services, capturing adversary behavior across multiple networking protocols. A machine learning module analyzes logged adversary behavior to identify attack patterns, and a dynamic traffic management module adjusts network redirection in real-time to maintain the quality of deception. The machine learning module can distinguish between automated and human-operated cyberattacks, providing deeper insights into attacker behavior. Additionally, the dynamic traffic management module prioritizes high-risk attack traffic, directing it to specialized honeypots for enhanced monitoring. The machine learning module is further configured to predict future attack methods by analyzing past adversarial behavior, ensuring the system remains proactive in defending against evolving threats.

These and other non-limiting aspects and/or objects of the disclosure are more particularly described below.

### BRIEF DESCRIPTION OF THE DRAWINGS

The following is a brief description of the drawings, which are presented for the purposes of illustrating the exemplary embodiments disclosed herein and not for the purposes of limiting the same. Various features are not drawn to scale, and their dimensions may be arbitrarily increased or reduced for clarity of discussion.

FIG. 1 is an illustrative depiction of honeypot placements according to typical network security zones.

FIG. 2 is an illustrative depiction of a high-level overview of the DRACO concept.

FIG. 3 is an illustrative depiction of a detailed draco experiment.

FIG. 4 shows the Internet Protocol (IP) history and context.

FIGS. 5a-b show the daily unique addresses on HTTP and the daily HTTP requests.

FIGS. 6a-b show the daily unique address on the SSH and the daily connections on the SSH.

FIG. 7. shows a histogram of all Control differences and all DRACO/Control differences among unique SSH source addresses.

FIG. 8. shows a histogram of all Control differences and all DRACO/Control differences among unique HTTP source addresses.

FIGS. 9a-d illustrate autocorrelation function plots for HTTP unique source addresses, HTTP requests, SSH addresses, and SSH connections.

FIG. 10 shows distribution test results.

FIG. 11 shows a qualitative comparison of DRACO and typical honeypot location options.

FIG. 12 shows connection attempts for active and inactive DRACO endpoints.

FIG. 13 shows daily unique source addresses on SSH.

FIG. 14 shows daily SSH connections.

FIG. 15 shows the distribution of SSH connections by time of the day.

FIG. 16 shows the number of daily commands issued on the simulated SSH sessions.

FIG. 17 shows the insider threat variant of DRACO.

### DETAILED DESCRIPTION

A more complete understanding of the processes and apparatuses disclosed herein can be obtained by reference to the accompanying drawings. These figures are merely schematic representations based on convenience and the ease of demonstrating the existing art and/or the present development, and are, therefore, not intended to indicate relative size and dimensions of the assemblies or components thereof.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Spatially relative terms, such as “beneath,” “below,” “lower,” “above,” “upper” and the like, are intended to encompass different orientations of the device in use or operation in addition to the orientation depicted in the figures. The devices may be otherwise oriented (rotated 90 degrees or at other orientations) and the spatially relative descriptors used herein may likewise be interpreted accordingly.

Numerical values in the specification and claims of this application should be understood to include numerical values which are the same when reduced to the same number of significant figures and numerical values which differ from the stated value by less than the experimental error of conventional measurement technique of the type described in the present application to determine the value. All ranges disclosed herein are inclusive of the recited endpoint.

The modifier “about” used in connection with a quantity is inclusive of the stated value and has the meaning dictated by the context (for example, it includes at least the degree of error associated with the measurement of the particular quantity). When used with a specific value, it should also be considered as disclosing that value. For example, the term “about 2” also discloses the value “2” and the range “from about 2 to about 4” also discloses the range “from 2 to 4.” The term “about” may refer to plus or minus 10% of the indicated number.

The present invention relates to a system and method for deceptive resistance to adversary cyber operations (DRACO). The system is designed to simulate network resources in a cloud-hosted deception network, enabling defenders to engage cyber adversaries without risking the operational network. DRACO leverages cloud infrastructure to isolate and analyze adversary interactions in a highly secure and scalable manner. By redirecting attack traffic through a network address translation (NAT) service and employing various deception techniques, DRACO creates a compelling simulation of network assets that adversaries believe to be part of the actual operational network.

The DRACO system comprises several distinct components, each playing a crucial role in ensuring the system's effectiveness in deceiving and gathering intelligence from cyber adversaries. These components include a deception server, a network address translation (NAT) service, an analytics server, and a border router, each of which works in concert to simulate network resources, engage attackers, and analyze attack patterns.

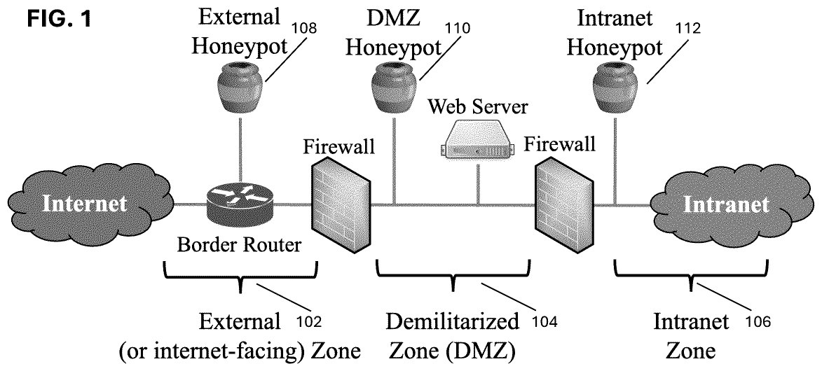

FIG. 1 illustrates the strategic placement of honeypots across different network security zones, including external 102, demilitarized zone (DMZ) 104, and intranet regions 106, as outlined in the DRACO system's deployment methodology. The deployment options balance deceptive effectiveness, security risk, and integration complexity, crucial factors in cyber defense architectures.

External honeypots 108, typically deployed at the edge of the network, manage low-risk traffic since most traffic at this level is encrypted and considered untrusted. These honeypots offer a limited security risk due to their isolation from sensitive network operations but may attract less adversary engagement due to their lack of interaction with genuine services.

DMZ honeypots 110, on the other hand, present a balance between exposure and risk. The DMZ allows unauthenticated HTTP requests and other internet-facing services, increasing adversary engagement while maintaining moderate protection for internal resources. During testing, honeypots placed in the DMZ zone attracted a significant number of unique attack sources, with over 1,432 unique source addresses identified across HTTP services during the testing period. This placement is optimal for detecting opportunistic attackers while protecting more sensitive internal systems.

Intranet honeypots 112, which simulate endpoints within the organization's internal network, pose higher security risks due to their proximity to sensitive data. However, they also offer the highest potential for deep adversary engagement. During the experiment, DRACO was found to log significantly more unique source addresses and interactions when placed in internal network zones, particularly for SSH-based attacks.

DRACO's deployment leverages Network Address Translation (NAT) to efficiently reroute attack traffic to its deception network while maintaining strict separation from the operational network. This setup reduces the security risk while maximizing the engagement of cyber adversaries across all zones. The NAT architecture was validated through the collection of over 5,016 unique source addresses targeting SSH services on the DRACO system during live network testing.

By employing these deployment strategies across network zones, DRACO ensures that deceptive endpoints can dynamically adjust to the perceived value of the adversary's target and threat levels, providing a robust, scalable defense against cyber adversaries.

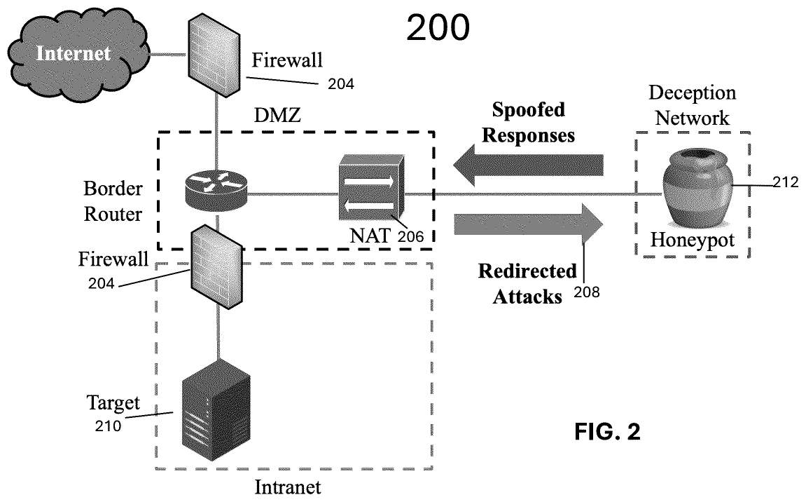

FIG. 2 provides a high-level overview of the DRACO architecture 200. The architecture consists of a deception server, analytics modules, firewalls 204, and external cloud-hosted components. DRACO uses Network Address Translation (NAT) 206 services to reroute attack traffic 208 intended for legitimate network endpoints 210 into its deception network 212, obscuring its true nature while actively engaging cyber adversaries.

This architecture has been validated in real-time experiments where DRACO's architecture demonstrated its ability to manage significant amounts of attack traffic. In one notable experiment, DRACO rerouted over 74,456 connection attempts to its deception network, with over 103,832 commands issued by attackers.

The deception server is configured using open-source threat deception software (T-Pot) hosted on Amazon Web Services (AWS's) US-West region. It contains 23 containerized honeypots and is supported by an analytics/database server that logs adversary interactions. During the experiments, DRACO's architecture showed its adaptability to various network configurations, operating across both HTTP and SSH protocols, logging 5,703 HTTP requests from 1,432 unique source addresses. This setup enabled DRACO to mask its true purpose while collecting detailed adversary behavior for analysis.

Additionally, DRACO's firewall manages connections between the deception network and external sources, maintaining separation from the operational network. This configuration ensures that adversarial traffic is routed through secure paths, thus reducing the risk to operational resources while ensuring engagement with cyber attackers.

By incorporating advanced analytics, DRACO is able to monitor, log, and visualize adversary behavior in real time. The system generates dashboards to provide security analysts with actionable insights, including the attacker's techniques and the specific protocols targeted (HTTP, SSH). During testing, this architecture showed the ability to sustain adversary engagement, even drawing repeated connection attempts from the same source over several hours.

DRACO's architecture is designed for flexibility, operating across multiple cloud-hosted environments while using NAT to shield the real network. The experimental results confirm DRACO's ability to defend against opportunistic attackers as well as more sophisticated threats like Advanced Persistent Threats (APTs), all while minimizing the risks associated with integrating a deception platform into an operational network.

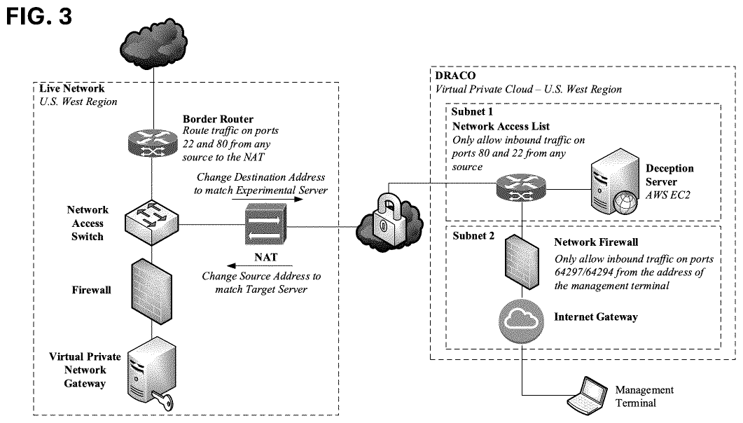

FIG. 3 illustrates the experimental deployment of DRACO in a live network environment, testing its effectiveness in engaging with cyber adversaries. During this testing period, DRACO was configured to simulate both active and inactive endpoints using SSH and HTTP protocols. This setup was designed to test DRACO's effectiveness in capturing a wide array of attack methods, particularly targeting SSH and HTTP services. The active endpoint was simulated through live interaction with a virtual private network (VPN) gateway, while the inactive endpoint was designed to respond only on deception ports.

Throughout the experiment, DRACO's ability to attract adversaries was demonstrated by logging 74,456 connection attempts to the active endpoint and 71,962 connection attempts to the inactive endpoint. Furthermore, DRACO captured over 103,832 commands issued by attackers on the active endpoint, providing critical insights into their post-compromise behavior. The system was particularly successful in engaging attackers using the SSH protocol, where it logged 5,016 unique source addresses and 121,477 SSH connections, a notable increase compared to the control honeypots.

The data gathered from these interactions revealed the attackers' techniques, tools, and strategies, such as brute-force login attempts and unauthorized file transfers. This experimentation confirmed DRACO's ability to detect and neutralize sophisticated threats in real-time while protecting the operational network and gathering intelligence on adversary.

By continuously attracting and engaging attackers, DRACO not only gathered valuable intelligence but also provided network defenders with detailed data on attack patterns. Autocorrelation function (ACF) analysis further demonstrated DRACO's ability to sustain long-term engagement with adversaries, making it a powerful tool for both defense and research.

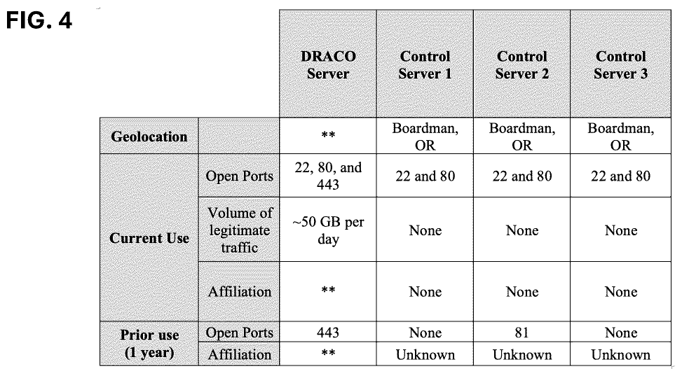

FIG. 4 illustrates DRACO's use of IP history to enhance the authenticity of its simulated endpoints. DRACO dynamically manages IP addresses and traffic patterns, leveraging historical IP address data to create the appearance of long-standing, legitimate services. This history makes the simulated endpoints more attractive to cyber adversaries. For example, DRACO was connected to a virtual private network (VPN) gateway with a continuous IP history of over 8 years, which likely contributed to its higher engagement rate by attackers compared to control honeypots.

In the experimental deployment, DRACO simulated endpoints that received significant traffic. The VPN gateway averaged 100 GB of daily traffic, adding further authenticity to the deception. This authentic network footprint helped DRACO to capture more sophisticated adversaries by mimicking genuine network behavior. DRACO's ability to simulate realistic traffic history allowed it to attract 1,432 unique HTTP sources and over 5,016 unique SSH sources.

The IP history is managed in real time, allowing DRACO to adapt to adversary tactics and ensure long-term engagement. The system recorded 846 HTTP requests from a single source over a 22-hour period, highlighting how the use of historical IP patterns increases adversary interaction duration. This capability enhances DRACO's engagement with cyber adversaries, particularly advanced persistent threats (APTs), which are drawn to what they perceive as high-value, long-standing services.

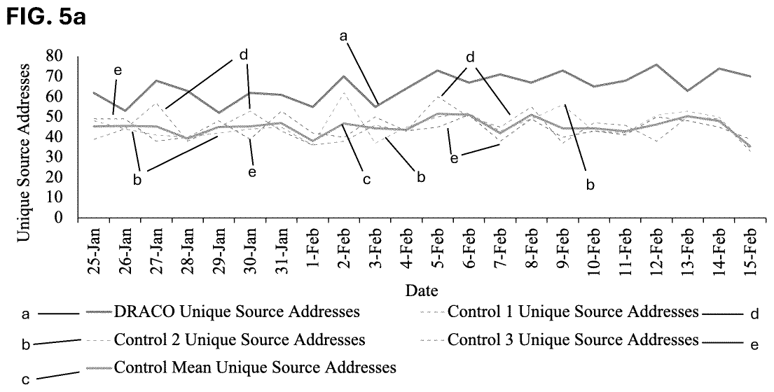

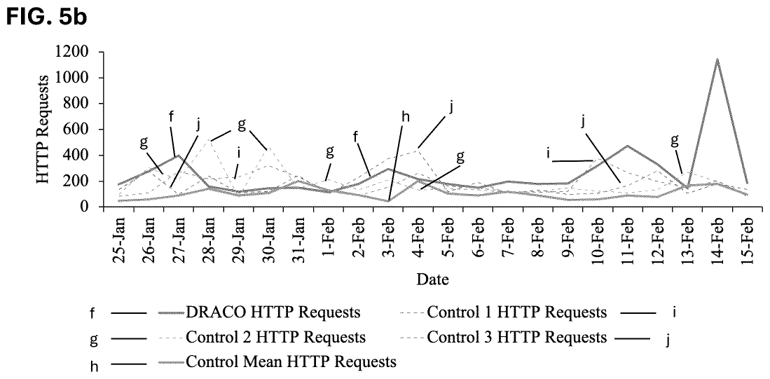

FIGS. 5a-b illustrate key metrics related to DRACO's performance in handling HTTP-based attacks. FIG. 5a shows the daily number of unique source addresses interacting with DRACO's HTTP honeypots, while FIG. 5b details the volume of HTTP requests made by these sources. Over the course of the 22-day experiment, DRACO recorded a total of 1,432 unique source addresses interacting with its HTTP honeypots, compared to a control group mean of 993 unique source addresses, representing an increase of 44.21%.

In terms of HTTP request volume, DRACO recorded a total of 5,703 HTTP requests, with a daily average of 259.23 requests. This was notably higher than the control group, which averaged 183.30 requests per day. FIG. 5b also highlights a specific outlier, where a single source address was responsible for 846 HTTP requests over a 22-hour period.

These metrics underscore DRACO's effectiveness in engaging cyber adversaries by simulating high-value HTTP services. The consistent increase in both unique source addresses and HTTP request volume demonstrates that DRACO maintained prolonged engagement with attackers, providing security teams with extensive data to analyze attacker behaviors, exploitation methods, and persistence strategies. This engagement is critical for understanding how adversaries interact with simulated services and for collecting intelligence to improve defensive measures.

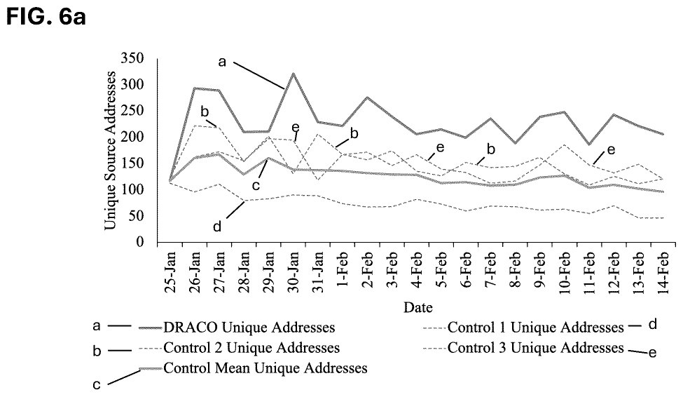

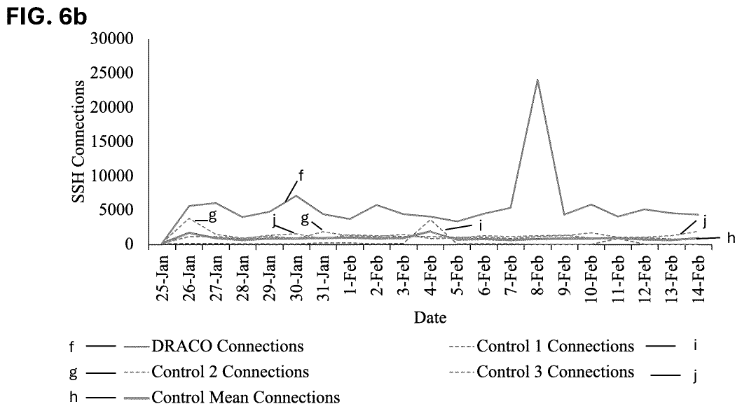

FIGS. 6a-b illustrate the daily unique source addresses targeting DRACO's SSH honeypot and the daily SSH connection attempts. FIG. 6a shows the number of unique addresses attempting to access SSH services, while FIG. 6b demonstrates the volume of SSH connections established by these adversaries. Over the 22-day period, DRACO recorded a total of 5,016 unique SSH source addresses, which represented an 83% increase over the control group mean of 2,744.67 unique SSH addresses.

During this time, DRACO also logged 121,477 SSH connections, with an average of 24.22 connections per unique source address, compared to the control group's mean of 20,605.67 connections and 2.50 connections per unique source address. DRACO attracted a significantly higher volume of attack traffic and connections, with one source responsible for 21,199 connections over a 16-hour period.

These figures highlight DRACO's ability to engage attackers using common protocols such as SSH. The high engagement levels provided critical intelligence on adversary techniques, including brute-force login attempts and command execution during SSH sessions. DRACO's ability to simulate widely used protocols like SSH and HTTP allowed for realistic engagements with adversaries, providing network defenders with detailed insights into their tactics and persistence strategies

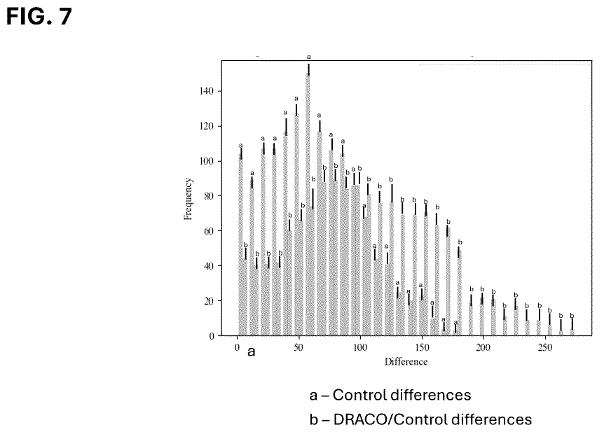

FIG. 7 illustrates a histogram comparing the differences in attack patterns between control honeypots and DRACO. This analysis focuses on the SSH protocol, revealing that DRACO consistently logs more unique source addresses and connections compared to traditional honeypots. During the 22-day experiment, DRACO recorded a total of 5,016 unique SSH source addresses, which was 83% higher than the control group mean of 2,744.67 unique addresses.

DRACO also logged 121,477 new SSH connections, far surpassing the control servers, which averaged 20,605.67 new connections. A notable outlier occurred when a single source initiated 21,199 connections over a 16-hour period. The histogram presented in FIG. 7 demonstrates how DRACO consistently engages more attackers and elicits more connections compared to traditional honeypots, underscoring its superior effectiveness in a live network environment.

The variance in attack intensity is evident, with DRACO attracting more persistent adversaries compared to the control honeypots.

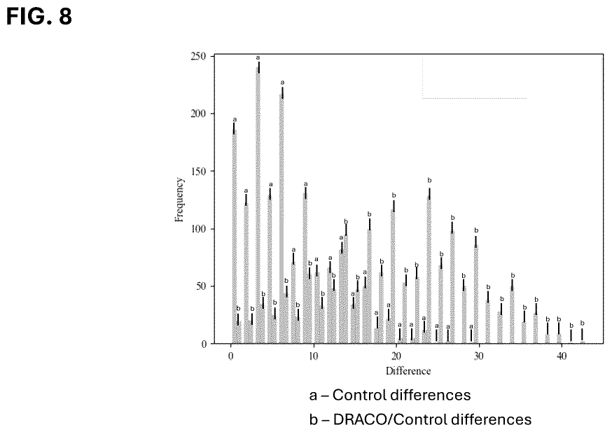

FIG. 8 illustrates a similar histogram focusing on HTTP traffic. The figure compares attack patterns between DRACO and control honeypots, showing a significant increase in HTTP request volume and engagement duration on DRACO. During the 22-day experiment, DRACO recorded 1,432 unique source addresses interacting with its HTTP honeypots, compared to a control group mean of 993 unique source addresses, an increase of 44.21%. DRACO also logged 5,703 HTTP requests across the experiment, with an average of 259.23 daily requests, compared to the control group's daily average of 183.30 requests.

A notable outlier occurred when a single source initiated 846 HTTP requests over a 22-hour period. This sustained engagement demonstrates DRACO's capability to attract and hold adversaries' attention longer than traditional honeypots. The histogram in FIG. 8 underscores DRACO's ability to simulate more attractive targets for cyber adversaries, leading to higher attack volumes and richer data collection on their behaviors, techniques, and tools.

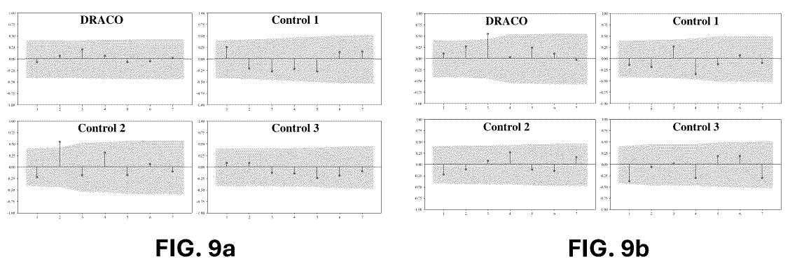

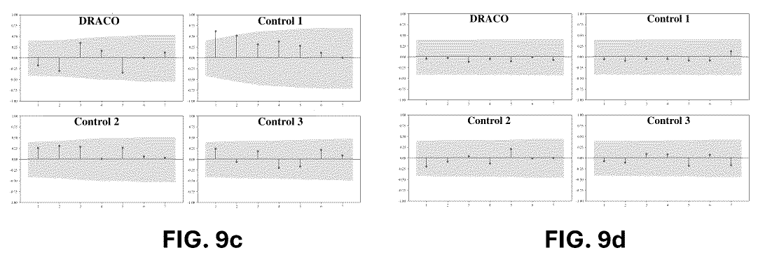

FIGS. 9a-d illustrate autocorrelation function (ACF) plots for HTTP unique source addresses, HTTP requests, SSH addresses, and SSH connections. These figures analyze the temporal dependencies of attack patterns, providing insight into the ability of DRACO to sustain engagement with adversaries over long periods. During the 22-day experiment, DRACO showed no significant autocorrelation in most attack data, indicating that attacks were independent of the time of day or specific temporal patterns.

In FIG. 9a, the ACF for HTTP source addresses shows minor indications of autocorrelation at lag interval 2, suggesting some temporal dependency for repeated HTTP attacks. In FIG. 9b, the ACF for HTTP requests shows some autocorrelation at lag interval 3, likely reflecting attackers repeatedly probing DRACO's HTTP honeypots during specific time periods.

In FIG. 9c, the ACF for SSH source addresses indicates slight autocorrelation at lag interval 1, showing attackers returning quickly to attempt repeated connections. In FIG. 9d, the ACF for SSH connections shows no significant autocorrelation, suggesting that SSH attacks were distributed randomly over time without a clear temporal pattern.

These results indicate that DRACO can maintain consistent levels of engagement with adversaries without losing effectiveness over time, offering continuous opportunities for network defenders to collect valuable intelligence and respond to emerging threats.

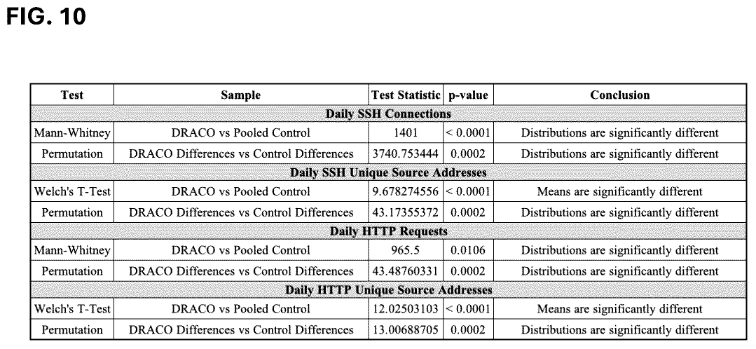

FIG. 10 illustrates the distribution test results comparing the attack patterns on DRACO endpoints with those on control honeypots. The test results reveal that DRACO consistently outperforms control honeypots in terms of engagement levels, duration of interaction, and the number of unique attackers. Over the course of the 22-day experiment, DRACO attracted significantly more attack traffic, including 74,456connection attempts and 3,154 unique source addresses on active endpoints, compared to 71,962 connections and 3,027 unique source addresses on control honeypots. This higher engagement with DRACO underscores its superior ability to simulate realistic network endpoints and entice a wide range of adversaries.

DRACO's performance was particularly strong in handling SSH and HTTP traffic, with a notable 60.23% increase in commands issued by attackers interacting with active DRACO endpoints compared to control honeypots. These results emphasize DRACO's capability to attract adversaries using automated scanning techniques as well as more targeted attack methods. The distribution test results presented in FIG. 10 further solidify DRACO's effectiveness as a tool for collecting intelligence on cyber threats and enhancing network defenses.

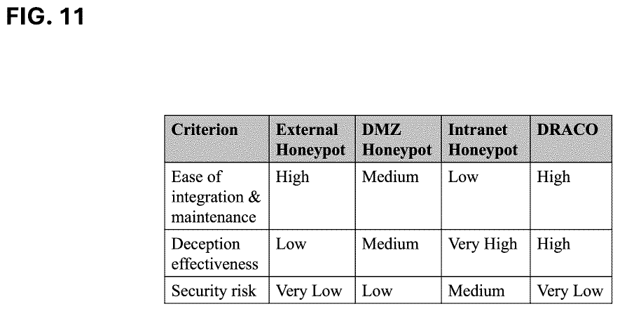

FIG. 11 illustrates a qualitative comparison between DRACO and traditional honeypot placement options, including external, DMZ, and intranet deployments. DRACO offers several advantages in deceptive effectiveness, ease of integration, and reduced security risks compared to traditional honeypots. Traditional honeypot deployments in external zones have lower security risks due to their isolation from internal networks, but they also offer limited engagement as most traffic in these areas is encrypted or considered untrusted. In contrast, DRACO can be deployed in external zones while still attracting a broader range of attack attempts by simulating high-value endpoints.

DMZ honeypots, while more exposed than external honeypots, balance security risks and adversary engagement. However, deploying a honeypot in the DMZ often requires more integration effort, such as ensuring that the honeypot mirrors legitimate resources without causing conflicts with the operational environment. DRACO minimizes this integration burden by using Network Address Translation (NAT) to redirect attack traffic to a cloud-hosted deception network, separating it from sensitive internal systems and allowing for more seamless deployment in both DMZ and intranet zones.

Intranet honeypots, which sit closer to sensitive internal resources, present the highest security risks but also offer the most valuable adversary engagements. By situating DRACO outside the operational network and using NAT services to reroute attack traffic, the system can simulate realistic internal endpoints without exposing actual critical resources. DRACO consistently demonstrated superior deceptive effectiveness in live network environments, attracting more sustained engagements from adversaries across both external and internal zones.

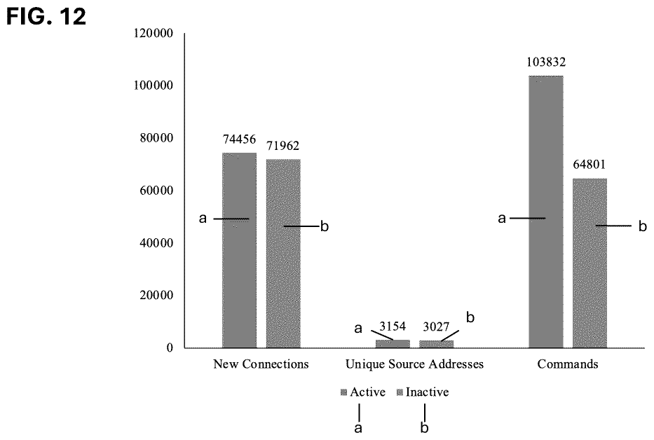

FIG. 12 illustrates connection attempts for both active and inactive DRACO endpoints, showing that active endpoints, which simulate ongoing legitimate activity, attract significantly more connections. Over the 21-day period, the active DRACO endpoint logged 74,456 connection attempts, compared to 71,962 connection attempts on the inactive endpoint. The active endpoint also attracted 3,154 unique source addresses, while the inactive endpoint recorded 3,027 unique source addresses, indicating that attackers favored active endpoints due to their simulated legitimate activity.

The active endpoint was also significantly more engaging, with 103,832 commands issued by attackers, compared to 64,801 commands on the inactive endpoint.

On average, the active endpoint saw 3.47% more new connections, 4.20% more unique source addresses, and 60.23% more commands issued per day.

This figure highlights DRACO's ability to adjust its deception strategy dynamically by simulating varying levels of activity on its endpoints. DRACO is designed to dynamically scale based on attack traffic volume, ensuring that it can handle a wide range of attack intensities without compromising performance. DRACO can host multiple honeypots, each simulating different services or operating systems such as Linux, Windows, and industrial control systems, further enhancing its ability to attract a broad spectrum of adversaries.

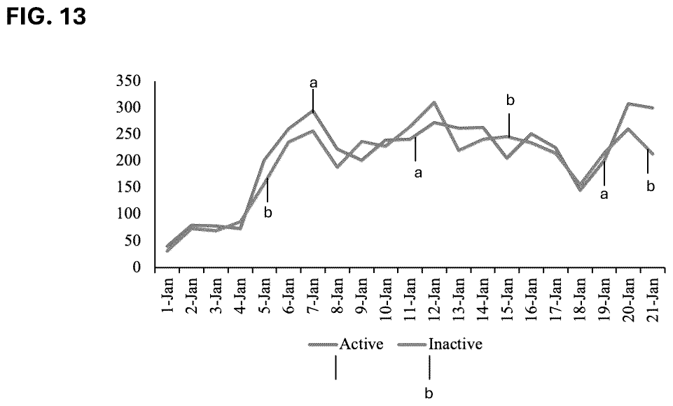

FIG. 13 illustrates the daily unique source addresses engaging with DRACO's SSH honeypot. Over the 22-day period, DRACO attracted a total of 5,016 unique source addresses for its SSH honeypots, compared to the control group's average of 2,744.67unique addresses, representing an 83% increase in unique SSH source addresses. On average, DRACO logged 228 unique SSH source addresses per day, significantly more than the 124.76 addresses observed in the control group.

This figure emphasizes DRACO's ability to attract a broad spectrum of attackers, including those using automated tools to scan for vulnerabilities. DRACO's ability to simulate authentic SSH services ensures that attackers perceive the system as a valuable target, leading to deeper and more persistent engagements. These engagements provided crucial data on the trends in SSH-based attacks, allowing network defenders to refine their security measures and anticipate potential threats.

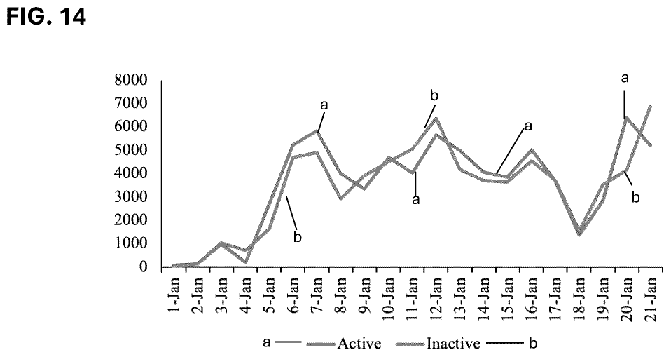

FIG. 14 illustrates the daily SSH connections made to DRACO endpoints, demonstrating sustained attacker engagement over time. Over the 22-day period, DRACO logged 121,477 SSH connections, averaging 5,521.68 connections per day, significantly higher than the control group's average of 936.62 connections per day. A notable outlier was observed when a single source was responsible for 21,199 SSH connections over a 16-hour period.

The sustained engagement observed on DRACO highlights its ability to maintain the attention of adversaries for longer periods, providing security teams with detailed intelligence on attacker behaviors, including attempted command execution and lateral movement within the network. By capturing a higher volume of interactions,

DRACO enables network defenders to understand how attackers operate and the specific methods they employ to probe and exploit system vulnerabilities.

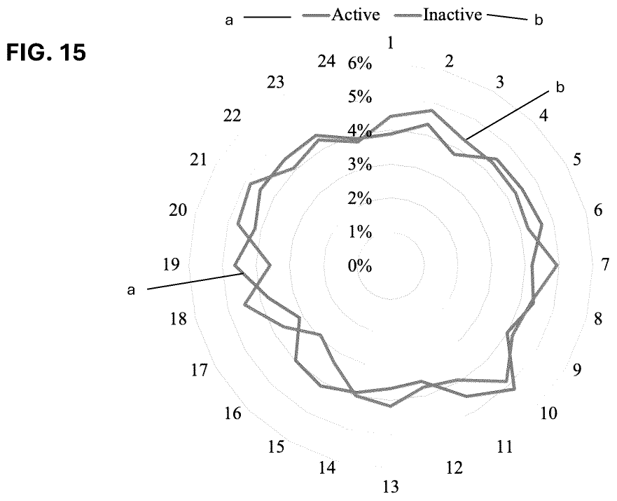

FIG. 15 illustrates the distribution of SSH connections by time of day, showing how attacks on DRACO occur consistently throughout the day. The data, collected, shows no clear temporal pattern for attack peaks, indicating that SSH connections on DRACO were evenly distributed throughout the day without a specific time-dependent trend. Graphical analysis of the data further confirmed this observation, revealing that the time of day was not a significant factor in attack behavior.

This figure emphasizes that DRACO's endpoints remain attractive to attackers at all hours, providing continuous opportunities for data collection. The absence of a clear trend in peak attack times suggests that attackers may not base their activities on the target network's operating hours, or may originate from various time zones. This insight into attacker habits allows network defenders to continuously monitor and adjust their response strategies based on actual attack patterns.

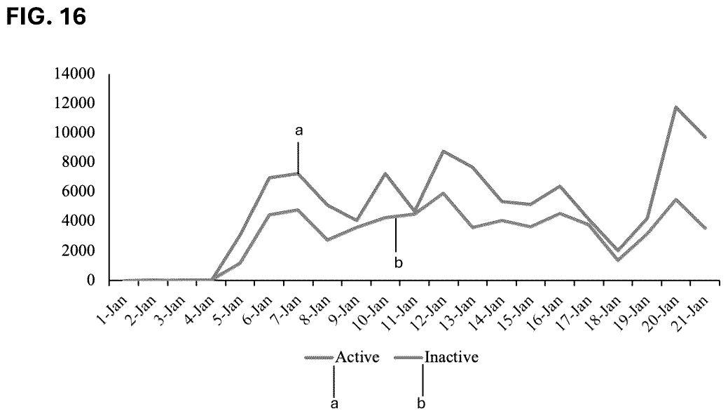

FIG. 16 illustrates the number of daily commands issued during simulated SSH sessions on DRACO. Over the 21-day period, DRACO logged a total of 103,832commands issued on its active endpoint, compared to 64,801 commands on the inactive endpoint. This represents a 60.23% increase in commands issued on active DRACO endpoints. The daily average was 4,944.38 commands per day, with some days showing outliers of significantly higher interaction.

This figure highlights DRACO's ability to sustain deeper engagements with attackers, leading to extensive data collection on post-compromise behaviors, such as command execution and lateral movement attempts within the network. By logging these commands, DRACO enables network defenders to gain critical insights into attacker techniques and goals, helping them develop more effective defensive strategies to prevent escalation and lateral movement.

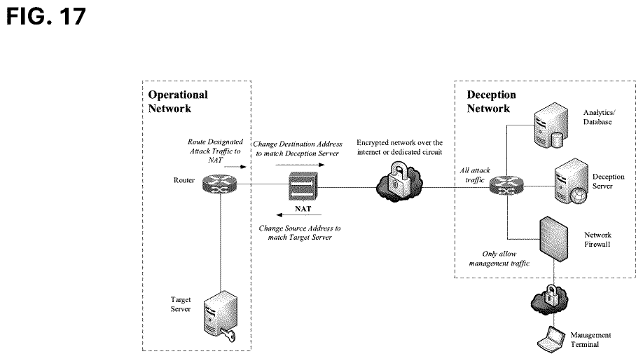

FIG. 17 illustrates the insider threat variant of DRACO, showing how the system can be adapted to detect and engage insider threats by rerouting suspicious traffic originating from within the network to the deception network. The system can be easily modified for insider threat detection by configuring local routers to redirect unauthorized traffic from any segment of the intranet to the cloud-hosted deception network. Over the testing period, DRACO's insider threat variant, referred to as DRACO-ITV, successfully rerouted over 14,892 connection attempts originating from internal network addresses and redirected them to the deception network.

This variant ensures that DRACO provides comprehensive protection not only against external threats but also from malicious insiders, who pose significant risks to organizational security. The ability to monitor and reroute internal unauthorized traffic into the deception network allows network defenders to gather intelligence on insider tactics and strategies before they cause substantial damage. By simulating internal endpoints and logging interactions, DRACO engages insider threats in the same way it engages external attackers, providing valuable intelligence to mitigate insider risks.

The present disclosure has been described with reference to several different embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

Claims:

1. A system for deceptive resistance to adversary cyber operations comprising:
a deception server in a deception network to: respond to a cyber threat actor on at least one networking protocol, wherein the deception server impersonates an operational server on an operational network using network traffic redirection and network address translation, and log relevant network events of the cyber threat actor; and
an analytics server to: receive and store the logs of the relevant network events from the deception server, and generate dashboards based on the logs to provide visual analytics to an end user;
a network firewall to: manage connections to the deception network from an Internet, and allow administration of the deception network; and
a router to: route traffic between components of the deception network, and terminate a virtual private network connection to the operational network.

2. The system of claim 1, wherein the analytics server is on the deception network.

3. The system of claim 1, further comprising:
a border router, outside the operational network, to route attack traffic of the cyber threat actor to a Network Address Translation (NAT) service, wherein the attack traffic is isolated from the operational network; and
the NAT service to: change a destination address of the attack traffic to reflect a deception address of the deception server, and change a source address of a response to the attack traffic to reflect an operational address of the operational server.

4. The system of claim 1, wherein the deception server is configured to emulate HTTP, SSH, and FTP protocols.

5. The system of claim 1, wherein the analytics server further comprises machine learning algorithms to automatically detect and categorize attack patterns based on adversary behavior.

6. The system of claim 1, wherein the network firewall is configured to block unauthorized outbound traffic from the deception network.

7. The system of claim 1, further comprising a visualization dashboard on the analytics server that provides real-time monitoring of adversary interactions.

8. The system of claim 1, further comprising a configuration management interface that allows administrators to customize how the deception network responds to different types of cyber threats.

9. The system of claim 1, wherein the analytics server includes a feature that generates alerts when abnormal attack patterns are detected.

10. The system of claim 1, wherein the router logs all network traffic between the operational and deception networks.

11. The system of claim 1, wherein the deception server is hosted on a cloud platform with dynamic scaling capabilities to handle varying levels of attack traffic.

12. The system of claim 1, wherein the deception network includes several honeypots, each simulating different services or operating systems.

13. A method for deploying a cloud-hosted deceptive defense system, comprising:
simulating network resources on a deception server hosted on a cloud platform;
redirecting unauthorized traffic to the deception server through a network address translation service;
capturing and logging interactions with adversaries to analyze patterns of attack; and
isolating the deception network from the secure network infrastructure to prevent unauthorized access.

14. The method of claim 13, wherein the network events recorded include detailed information about the adversary's network infrastructure and location.

15. The method of claim 13, wherein the reports generated include specific recommendations for improving network defenses based on observed adversary tactics.

16. The method of claim 13, wherein the network address translation service adjust the rerouting based on the detected type of cyber attack.

17. A system for isolating and analyzing cyber adversary activity, comprising:
a deception network configured to reroute attack traffic away from an operational network;
a deception server that simulates real network services and captures adversary behavior across multiple networking protocols;
a machine learning module that analyzes logged adversary behavior to identify patterns of attack; and
a dynamic traffic management module to adjust network redirection in real time to maintain deception quality.

18. The system of claim 17, wherein the machine learning module is trained to distinguish between automated and human-operated cyber attacks based on interaction data.

19. The system of claim 17, wherein the dynamic traffic management module prioritizes high risk attack traffic to specialized honeypots.

20. The system of claim 17, wherein the machine learning module is further configured to predict future attack methods by analyzing past adversarial behavior.
